(19) United States
(12) Patent Application Publication
(10) Pub. No.: US 2026/0278612 A1
(43) Pub. Date: Sep. 17, 2026

(54) Automation Process and Risk Assessment

(71) Applicant: Dan Herbatschek, New York, NY (US)

(72) Inventor: Dan Herbatschek, New York, NY (US)

(21) Appl. No.: 19/076,677

(22) Filed: Mar. 11, 2025

(51) Int. Cl. G06Q 20/40; G06Q 30/0601; G06Q 40/03

(52) U.S. Cl. CPC G06Q 20/4016; G06Q 20/403; G06Q 30/0631; G06Q 40/03

(57) ABSTRACT

A method implemented on a vehicle sales device for providing determining risk associated with a potential vehicle transaction is disclosed. The method may include receiving a set of information associated with a potential vehicle buyer, wherein the set of information includes at least one financial metric and at least one biographical information. The method may include determining a set of criteria for a risk assessment for the potential vehicle buyer based on the set of information. The method may include determining a risk profile based on the set of criteria as applied to the set of information. The method may include determining whether the risk profile is within a threshold. The method may include upon a determination that the risk profile is within the threshold, initiate a process to complete a transaction associated with the potential vehicle buyer and the vehicle.

### BACKGROUND

### Field

The present disclosure relates to the field of vehicle sales systems, and more particularly, to the field of vehicle sales systems used in a car dealership environment proving for improved processing of the sales process.

### BACKGROUND

Many people look forward to the prospect of buying a new car. This process, however, has historically been a manual process necessitating considerable amount of manpower with the attendant errors. The car sales process has sometimes suffered poor reputation due to inconsistent interactions; for dealerships, the manual processes have sometimes introduced errors and omissions during the process to complete a transaction. As well, compliance with regulatory requirements are sometimes frustrated due to the manual hurdles. In addition, sales opportunities are sometimes missed due to the above shortcomings.

In some cases, rudimentary computer systems have been provided for the sales process; these rudimentary systems, however, fail to provide adequately for an improved risk assessment process.

Accordingly, there is a need for improved systems and methods that address these above shortcomings in the vehicle-buying process.

### SUMMARY

In an aspect of the disclosure, a method implemented on a vehicle sales device for providing determining risk associated with a potential vehicle transaction is disclosed. The method may include receiving a set of information associated with a potential vehicle buyer, wherein the set of information includes at least one financial metric and at least one biographical information. The method may include determining a set of criteria for a risk assessment for the potential vehicle buyer based on the set of information. The method may include determining a risk profile based on the set of criteria as applied to the set of information. The method may include determining whether the risk profile is within a threshold. The method may include upon a determination that the risk profile is within the threshold, initiating a process to complete a transaction associated with the potential vehicle buyer and the vehicle.

In another aspect of the disclosure, a method implemented on a vehicle sales device for intake processing is provided.

In another aspect of the disclosure, a method implemented on a vehicle sales device for reviving a sale is provided.

### BRIEF DESCRIPTION OF THE DRAWINGS

The present disclosure is illustrated by way of example, and not by way of limitation, and may be more fully understood with reference to the following detailed description when considered in connection with the figures below.

FIG. 1 is an exemplary block diagram illustrating an exemplary dealership location in accordance with embodiments of the disclosure.

FIG. 2 is an exemplary block diagram illustrating a system enabling features associated with the car-shopping process between a customer and a dealership using a customer vehicle purchasing device and a dealership vehicle sales devices.

FIG. 3 is an exemplary block diagram of the dealership vehicle sales device.

FIG. 4 illustrates exemplary data structures used in conjunction with the systems and methods of the disclosure.

FIG. 5 shows exemplary data relationships used in conjunction with the systems and methods of the disclosure.

FIG. 6 is an exemplary diagram illustrating a display screen on a customer vehicle purchasing device.

FIG. 7 is an exemplary diagram illustrating a display screen of a dealership vehicle sales device.

FIG. 8 is an exemplary flow diagram illustrating a method for determining risk associated with a vehicle purchase or transaction.

FIG. 9 is an exemplary flow diagram illustrating a method for intake processing of customers associated with a vehicle transaction.

FIG. 10 is an exemplary flow diagram illustrating a method for reviving a sale subsequent to a disqualification determination.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Methods and systems are provided for facilitating an improved vehicle-shopping experience. In the disclosure, “vehicle” may refer to automobiles, but the term may refer generally to cars and trucks, and other types of transportation vehicles including, for example, motorcycles, watercraft, aircraft, spacecraft, and the like. The vehicle-shopping experience may include customers on the one hand seeking to acquire or take possession of a vehicle through purchase, lease, rental, or through other means or transactions. On the dealership side, the complement of staff may include the range of personnel from the greeters, to the salespeople, to the finance people, and other staffers. A customer may be referred to as a client, a guest, an end user, a user, or other suitable language. The experience may be described as a car-shopping or vehicle-shopping experience; the experience may refer to buying, leasing, renting, or any other suitable permanent or temporary possession or acquisition of a vehicle.

The vehicles may include, for example, gas, diesel, or electric-vehicle and other types of new-energy and new-propulsion systems or manually-propelled systems. The vehicle-shopping experience may be performed on a mobile device. Such a mobile device may be similar to a computing device (e.g., a computer, a laptop computer, a smart phone, a tablet, a wearable device, or any other suitable electronic apparatus). In another example, the computing device may be specially programmed or specially configured to be a special-purpose computing device capable of performing the methods disclosed herein. Advantages disclosed herein include enabling reliable, consistent, cost-effective, engaging, and an enjoyable shopping experience for the customer.

The methods may enable intake of customer information before or at the point of a dealership showroom (e.g., a car dealership) or other suitable location or environment. In some embodiments, the systems and methods may provide for risk assessment of customers for purchase of a vehicle. In some embodiments, the systems and methods may provide for improved intake and reliability of intake information to improve the experience of the sales process as well as improving the chances of a sale of the desired vehicle or a different vehicle. In some embodiments, the improved process may provide for transaction of goods or services other than a vehicle. In some embodiments, the systems and methods may provide for reviving a sales lead.

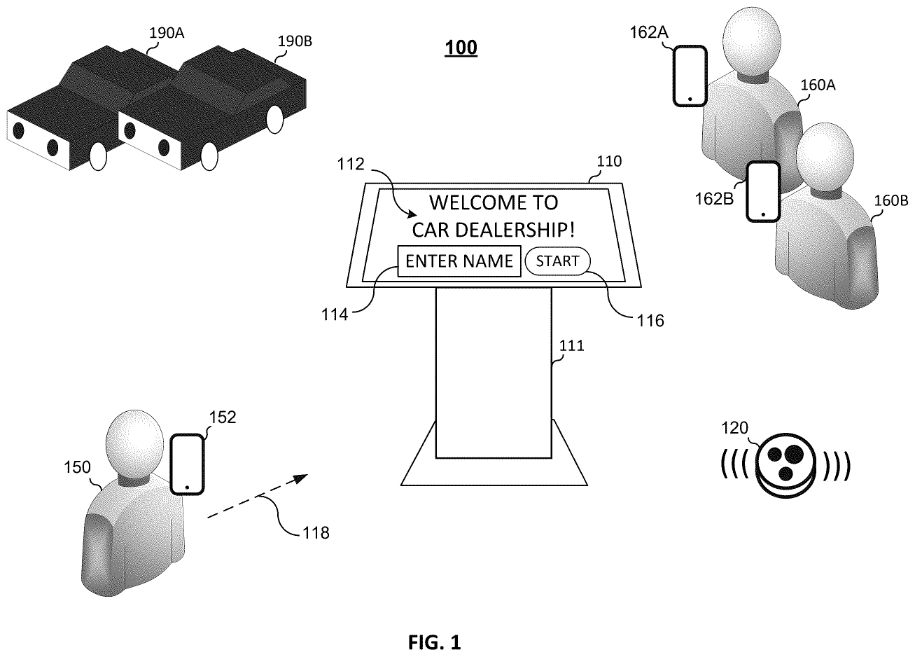

Reference is now made to FIG. 1, which illustrates an exemplary dealership 100 location. The dealership 100 location may be a physical store or showroom. Inventory of the dealership 100 may include new or used vehicles, such as vehicles 190A, 190B. These vehicles 190A, 190B may be on display on the premises of the dealership 100 to customers (as illustrated) or kept in storage (e.g., on-site or off-site).

In the example of FIG. 1, a customer 150 with a mobile device 152 may approach the dealership 100, for example, for the purpose of buying a new vehicle. The customer's mobile device 152 may also be referred to as a customer vehicle purchasing device 152, a customer device 152, or other suitable terminology. As illustrated, the customer 150 may approach 118 a kiosk including a dealership vehicle sales device 110 (or kiosk device 110). The kiosk device 110 may be a starting point for the car buying experience. For example, the kiosk device 110 may include a welcome message 112 with options for the customer to enter the customer's information 114 and user interface element(s) 116 to begin the experience. Staff members 160A, 160B of the dealership may include various personnel to perform the duties of the various steps including, for example, greeting the customer to finalizing a sale.

At the dealership 100, there may be one or more sensors 120 that may be configured to collect input from the environment, the customers, staff, or any other suitable inputs for the sensor 120. The collected data from the sensor 120 may be used for the various methods of the disclosure. For example, the sensor 120 may collect audio, video, or other inputs. While the various features such as the kiosk device 110 and sensor 120 are shown as separate and distinct elements, in other embodiments, they may be combined as suitable, such as using combined or separate hardware and software modules residing on either or both of the customer's mobile device 152 or staffs'mobile devices 162A, 162B. The staff mobile devices 162A, 162B may be referred to as a dealership vehicle sales device, dealership device, or other suitable terminology.

In some embodiments, the experience or transaction may be facilitated through one of the devices, such as kiosk device 110 or one of devices 162A, 162B. In such an embodiment, the customer and dealership staff may interact with one common device.

Kiosk device 110 is shown in the example of FIG. 1 attached to a large fixture 111 for the sake of convenience of usage by customers and dealership staff. Those skilled in the art will appreciate that the kiosk device 110 is not so limited in portability. While some examples may include a kiosk device 110 as an integral part of fixture 111, in other examples, the kiosk device 110 may be a mobile device separably attached to the fixture 111.

While the dealership 100 is described as a physical store, those skilled in the art will appreciate that the disclosure is not so limited. In other embodiments, the dealership may be a virtual store with all features shown in FIG. 1 represented as avatars in an online system such a virtual reality system or other suitable presentation media. In some examples of an online shopping experience, the car-shopping experience may be performed by the mobile device 152 in communication with one or more of devices 110, 162A, 162B.

While FIG. 1 shows one exemplary configuration of devices, those skilled in the art will recognize that any suitable combination of devices may be used. In some examples, the sensor 120 may be omitted, or multiple such sensors 120 may be present in various locations and configurations (e.g., coupled to or integrated with the other various devices).

As well, while the example of FIG. 1 includes reference to a customer 150 making an approach 118 within the dealership 100, it should be apparent to those skilled in the art that other states, conditions, and processes may be used in addition to, or in lieu of, the example of FIG. 1. In other examples, the transaction may be facilitated without the physical presence or physical actions of the customer (e.g., for a remote or off-site sales or for a virtual car shopping experience).

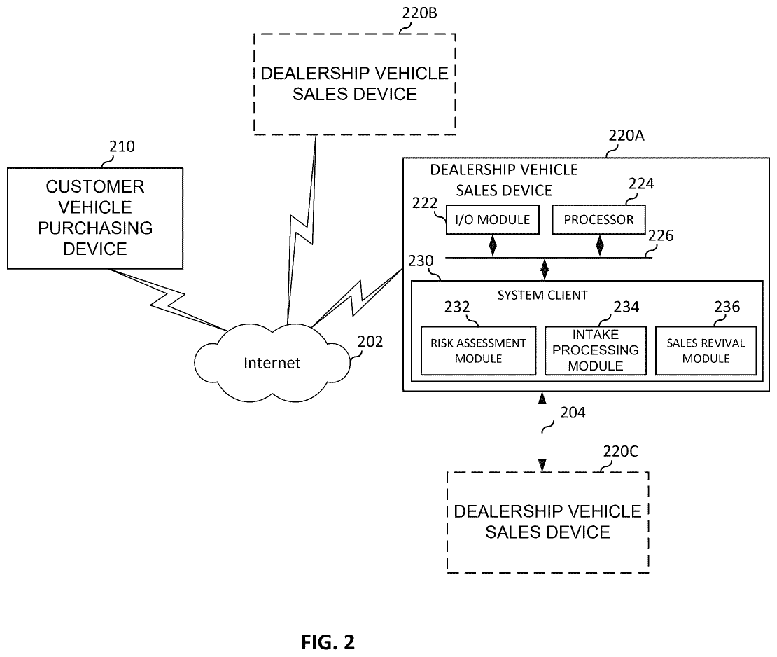

Reference is now made to FIG. 2, which illustrates a system enabling features associated with the car-shopping process between a customer and a dealership using a customer vehicle purchasing device 210 and dealership vehicle sales devices 220A-C. For example, the features may configure the system for risk assessment determination, intake processing, and sales revival through the risk assessment module 232, intake processing module 234, and sales revival module 236, respectively.

In some embodiments, dealership vehicle sales devices, e.g., 220A-220C may be linked within a local area network 204 or any other suitable data or connection link. In other embodiments, the devices 220B, 220C may be optional so that one device, such as device 220A, may handle the entire process.

In some embodiments, the dealership vehicle sales device 220A may be in communication with the customer vehicle purchase device 210 via the internet 202, with the dealership vehicle sales device 220A facilitating the experience or transaction. In yet other embodiments, the dealership vehicle sales device 220A may include functionality to facilitate the processes without needing other separate devices.

In accordance with an exemplary embodiment, data including video, audio, biometric information, or any other suitable information may be shared between the various devices. Data including audio, video, or text from device 210 or devices 220A, 220B, 220C may be shared with the other devices via the Internet 202 and/or any other suitable communication network such as, for example but not limited to, a wide area network (WAN), a local area network (LAN), a mobile communication network, a satellite communication link, a landline telephone service, etc.

Device 220A may include processor 224, I/O module 222, data bus 226, and system/device client 230. It will be appreciated that device 220A may include hardware and software components, such as are well-known in the art. It will similarly be appreciated that device 220A may include other components not depicted in FIG. 2. Device 220A may include more than one processor 224. For example, one such processor 224 may be a special purpose processor operative to execute client 230. Client 230 may include an application that is implemented in software and/or hardware on device 220A. Client 230 may be any suitable application for management and/or sales including commercial off-the-shelf software from a software vendor or may be purpose-built software. In accordance with embodiments described herein, client 230 may include a risk assessment module 232 configured for determining risk assessment. Client 230 may include an intake processing module 234 configured to provide intake processing (e.g., initial gathering/collection of customer information). Client 230 may include a sales revival module 236.

I/O module 222 may be a hardware and/or software component that may be configured to transmit and receive data to and from devices in communication with device 220A. In an example, I/O module 222 may be implemented as a transceiver. Device 220A may be configured to use I/O module 222 to facilitate sharing of data with other devices based on instructions of client 230.

It will be appreciated that each of the devices 210, 220A-C may be configured and implemented in accordance with any of the configurations described herein with relation to customer vehicle purchasing device 210 or dealership vehicle sales devices 220A-C.

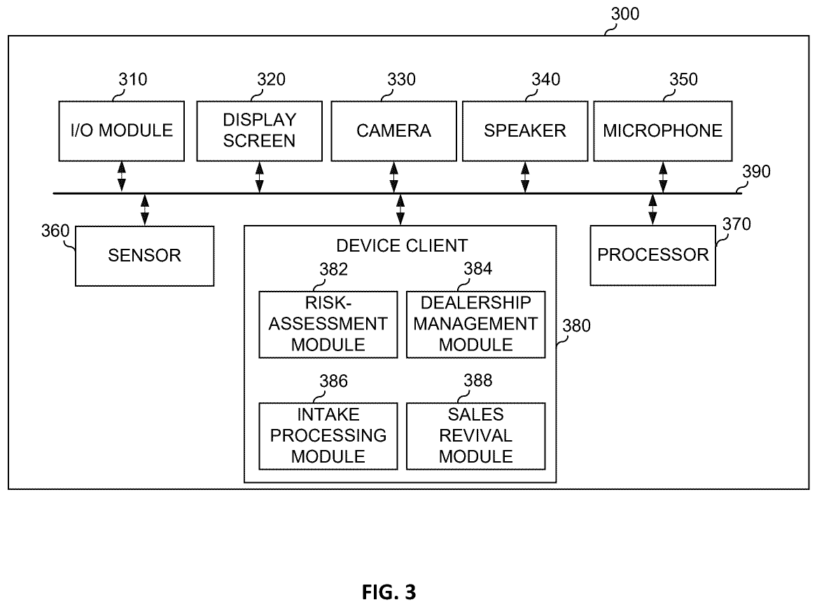

FIG. 3 is an exemplary block diagram of the dealership vehicle sales device 300, for example, representing device 220A of FIG. 2.

Alternatively, the block diagram may represent the customer vehicle purchasing device 210, with suitable modifications for the customer vehicle purchasing device 210. In the case of the customer vehicle purchasing device 210, the device may be a specially designed device, or the device client 380 may be an application (e.g., a mobile application) running on a customer's own device. In another embodiment, the customer vehicle purchasing device 210 may be a specially designed device used for the purposes of transactions. For example, the devices may be provided by a dealership.

Dealership vehicle sales device 300 may include processor 370, I/O module 310, display screen 320, camera 330, one or more speakers 340, microphone 350, biometric sensor 360, data bus 390 used for communication between the components, and device client 380, which may be implemented as either a software application and/or hardware component and may be executable by processor 370 to facilitate the processes of the experience during a sales process as depicted in FIG. 1. Processor 370 may also operate I/O module 310, display screen 320, camera 330, speaker 340, microphone 350, and biometric sensor 360 in support of the sales process as per instructions provided by device client 380. For example, I/O module 310 may send and receive audio/video data between the customer, staff members (or between staff members); received video data may be displayed on display screen 320; camera 330 may provide video data to be sent to other devices 300; speaker(s) 340 may play the received audio data; microphone 350 may provide audio input to be sent to other devices 300; and biometric sensor(s) 360 may read biometric data from a user (e.g., the customer) of the device 300 to send to another device (not shown) (e.g., a staff of the dealership using another device).

In some embodiments, the device 300 may provide any of a variety of services to the customer or between staff of the dealership; in other embodiments, the device 300 may be used as a standalone device for internal management of the dealership.

In accordance with embodiments described herein, device client 380 may include a risk assessment module 382. As will be described below, risk assessment module 382 may be configured to perform risk analysis and assessment routines on device 300. For example, the risk assessment module 382 may receive, as input data, customer information such as biographical information and a financial attribute to provide a risk metric. Biographical information may include any combination of name, address, age, demographic metrics, etc. The risk metric may be a binary metric which may indicate approval or disapproval of a vehicle transaction. In some examples, the risk assessment module 382 may receive information of a soft credit indication (for example, without a “hard” credit pull from a credit rating agency or organization). The risk assessment module 382 may provide an indication of a pre-qualification of the customer based on the input data. In other examples, the risk assessment module 382 may receive information associated with a hard credit pull. In such a case, the transaction may affect a credit rating score of the customer.

In some embodiments, the risk assessment module 382 may include guidance to one or both of the customer and dealership staff in order to make the risk determination. For example, the risk assessment module 382 may ensure compliance with regulatory requirements, such as customer authorization (e.g., signature collection) for one or more of the steps. In some examples, the risk assessment module 382 may provide alerts to the dealership staff in case of missing information, or missing steps to the risk assessment.

Device client 380 may include an intake processing module 386. In some embodiments, intake processing module 386 may be configured to collect customer information and other suitable information. Intake processing module 386 may be a module (e.g., a mobile application) running on a customer device or on a dealership device. The intake processing module 386 may gather information explicitly, e.g., through user prompts, or may gather information based on information already stored on the customer's device or through information stored on other devices or media. In some embodiments, intake processing module 386 may gather information through the kiosk device 110 as illustrated in FIG. 1. In other embodiments, the intake processing module 386 may be coupled to one or more sensors (e.g., sensor 360 or sensor 120A of FIG. 1) to gather information associated with the customer.

Device client 380 may include a sales revival module 388. Sales revival module 388 may be configured to provide routines to revive a potential lost sale or to offer an alternative transaction to an original intended transaction. In an example, a customer may have a desire to purchase a desired vehicle, but the customer may not qualify (e.g., based on the risk assessment module 382 determination of disqualification). In this case, the sales revival module 388 may determine an alternative vehicle or an alternative transaction of other goods or services for the customer. In some examples, these alternative goods or services may include other vehicles such as lower-cost alternatives, competing brands (although these options may be present or omitted based on preferences and suitability to a dealership or business), other types of vehicles such as scooters, or other alternative services or transportation modes. While the above is presented in perspective of finding lower-cost alternatives, the disclosure is not so limited. Those skilled in the art will recognize that a sales revival process may, in some instances, present more expensive options if the options are applicable to a customer, and the customer has the desire and/or ability to contemplate such transaction.

The sales revival module 388 may rely on output of the risk assessment module 382 based on a determination of a disqualification indication. The sales revival module 388 may rely on information from the intake processing module 386. In some embodiments, the sales revival module 388 may rely on information received from sensors (e.g., from the sensors themselves, via the intake processing module 386, or through some other pathway for receiving the information).

Device client 380 may include a dealership management module 384. The dealership management module 384 may provide routines for management of a dealership. For example, such management may include accounting/business, sales/transactions/finance, inventory, staff management of the dealership. In some embodiments, the module 384 may provide routines for communication and management between two or more dealerships.

Each of modules 382, 384, 386, 388 may be implementable either as a software application and/or hardware component that may be implemented as either an integrated component of device client 380 or as an independent module in communication with device client 380. Those skilled in the art will recognize that the features of modules 382, 384, 386, 388 may be used individually, or may be used in conjunction in any combination to provide the features of the disclosure.

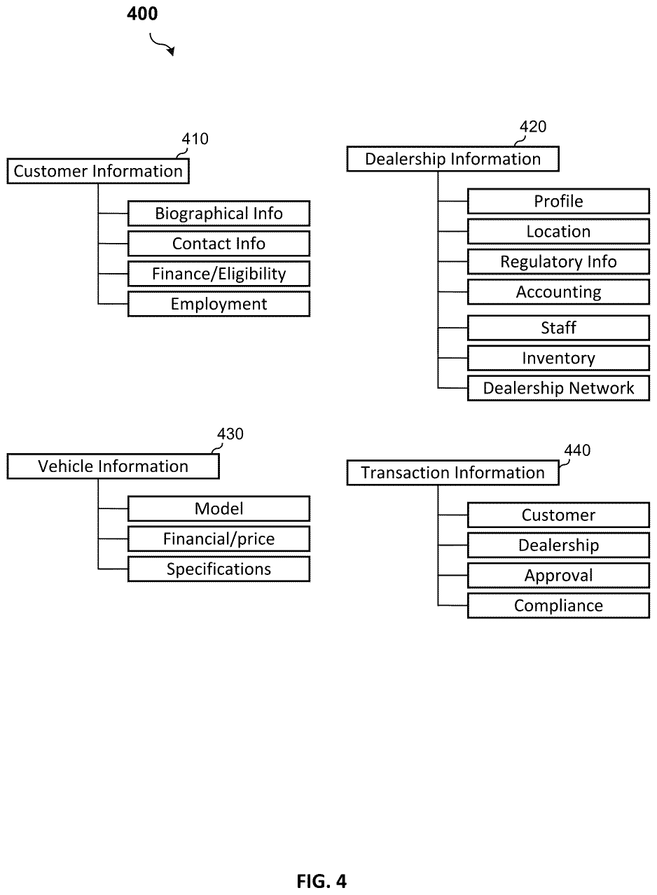

FIG. 4 shows exemplary data structures 400 used in conjunction with the systems and methods of the disclosure. For example, the data structures 400 may be used by the devices of FIG. 2 or device 300 of FIG. 3 with processing by device client 380.

As illustrated in FIG. 4, the data structures 400 may include tables and values for the various entities represented in the disclosure. The data tables may include customer information 410, dealership information 420, vehicle information 430, and transaction information 440. Customer information 410 may include values such as biographical information, contact information, finance/eligibility, and employment. Dealership information 420 may include dealership profile, location, regulatory information, accounting, staff, inventory, dealership network, etc. Vehicle information 430 may include model, financial/price, and specifications. Transaction information 440 may represent a transaction (e.g., a sale/lease/rental) of a vehicle to a customer. Transaction information 440 may include values of customer, dealership, approval, and compliance.

While the tables shown in FIG. 4 may represent some of the entities with some values, those skilled in the art will recognize that other tables and values may be used in addition or in the alternative to the ones shown. In other embodiments, other types of suitable data structures may be used where appropriate.

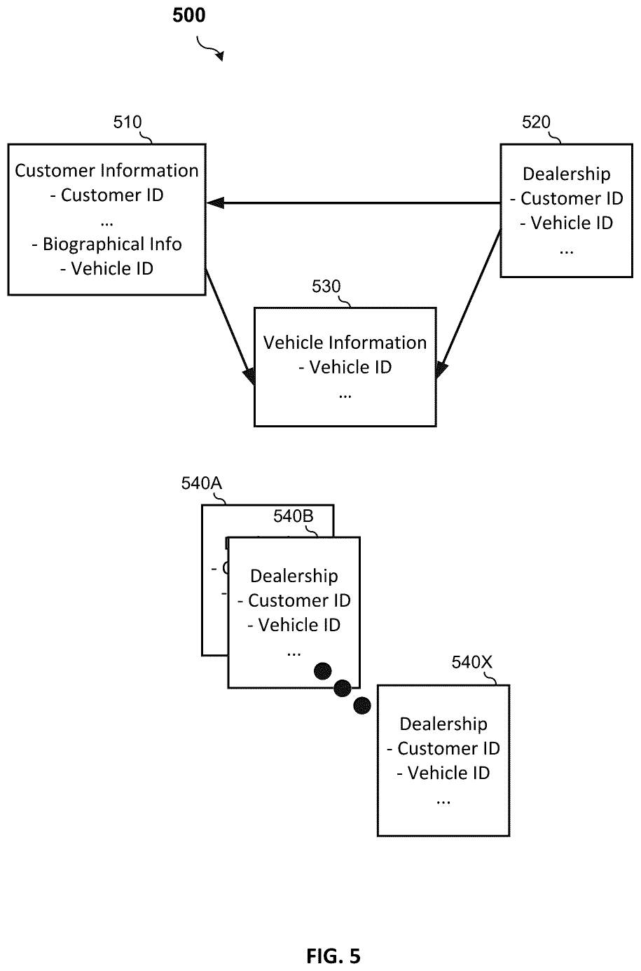

FIG. 5 shows exemplary data relationships 500 used in conjunction with the systems and methods of the disclosure. The data relationships 500 may include relationships between customer information 510, vehicle information 530, and the dealership information 520. The dealership may store sets of information relating to customers and vehicles 540A-X.

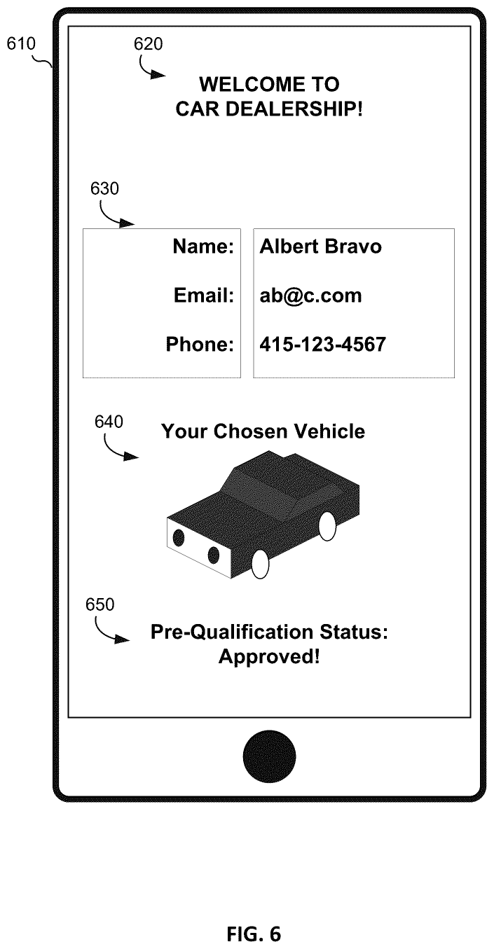

FIG. 6 is an exemplary diagram illustrating a display screen on a customer vehicle purchasing device 610, such as device 210 of FIG. 2. The example screen may include a header 620, biographical information 630, a desired vehicle 640, and financial status 650 for the customer. The biographical information 630 may be manually provided by the customer. In other embodiments, the biographical information 630 may be collected automatically, without input from the customer, e.g., based on previous input of the customer on the device 610 or through other sources associated with the customer. In some embodiments, a status may be provided to the customer. In the example of FIG. 6, a pre-qualification status (e.g., approved or not approved) may be provided, shown as “approved” in the example.

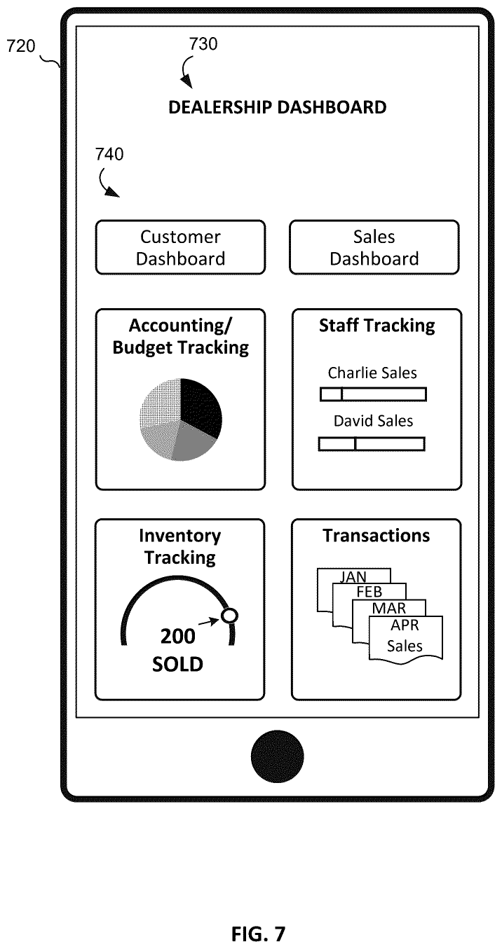

FIG. 7 is an exemplary diagram illustrating a display screen of a dealership vehicle sales device 720. The dealership vehicle sales device 720 may be, for example, one of devices 220A, 220B, 220C of FIG. 2 or device 300 of FIG. 3. In the example, the device 720 display screen may include a dealership header or label 730 indicating a dashboard screen. The device 720 display screen may include graphical user interface (GUI) elements 740 for options to interface with the customer dashboard, sales dashboard, accounting/budget tracking, staff tracking, inventory tracking, or transactions. Those skilled in the art will recognize that other GUI elements may be used in addition or in the alternative to the ones shown to suit the needs and desires of a dealership.

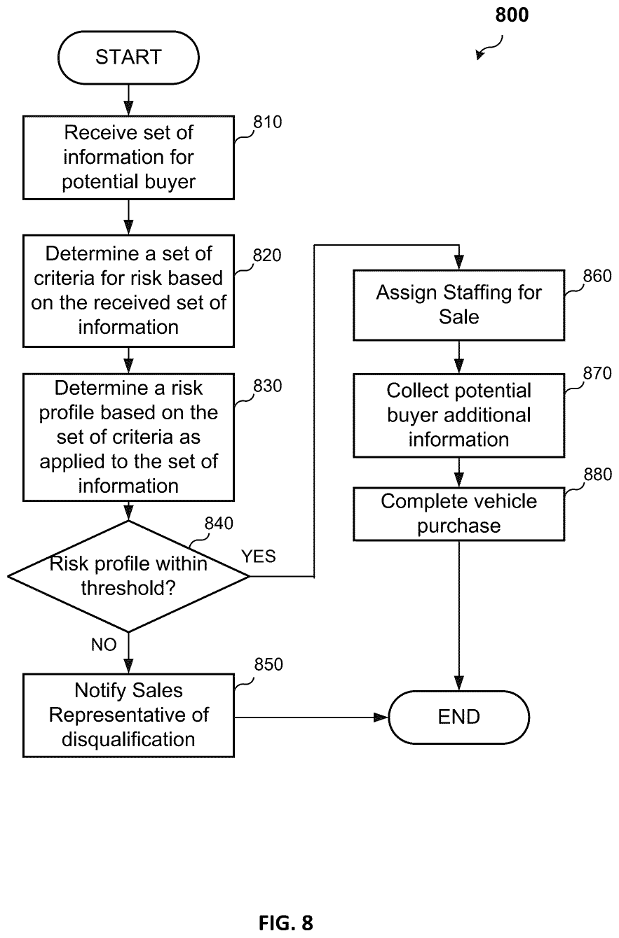

FIG. 8 is an exemplary flow diagram illustrating a method 800 for determining risk associated with a vehicle purchase or transaction. The method 800 may be performed by a mobile device, such as dealership vehicle sales devices 162A, 162B of FIG. 1, or 220A, 220B, 220C of FIG. 2, or device 300 of FIG. 3. The method may be methods of the device client 380 and/or the risk-assessment module 382, alone, or in combination with other modules such as modules 384, 386, 388.

Starting at step 810, the method 800 may include receiving a set of information for a potential buyer. In one embodiment, the set of information may be collected/gathered from a customer device, such as device 152 of FIG. 1 or device 210 of FIG. 2 or device 300 (when serving as a customer device) of FIG. 3. In another embodiment, the set of information may be collected/gathered from, e.g., the dealership vehicle sales devices 110, 162A, 162B of FIG. 1, devices 220A, 220B, 220C of FIG. 2, or device 300 of FIG. 3. In some embodiments, the set of information may be collected from a prompt of the customer; in other embodiments, the set of information may be collected without customer input.

At step 820, the method 800 may include determining a set of criteria for risk based on the received set of information. At step 830, the method 800 may include determining a risk profile based on the set of criteria as applied to the set of information. At step 840, the method 800 may include determining whether the risk profile is within a threshold. For example, step 840 may include determining a financial qualification of the customer/buyer for purchase of a vehicle. In some cases, the determination may be based on the buyer information including the buyer's financial metrics such as income or credit rating. At step 840 or earlier, the method may include generating an adverse action letter.

If the method 800, at step 840, determines that the risk profile is not within the threshold (e.g., the customer is not qualified or not approved) then the method 800 may proceed to step 850. If the method 800, at step 840, determines that the risk profile is within the threshold (e.g., the customer is qualified or approved) then the method may proceed to step 860. At step 850, the method 800 may notify a sales representative of the disqualification. The method may end after step 850.

Returning to step 840, if the method 800 determines that the risk profile is within the threshold, then the method may proceed to step 860. At step 860, the method 800 may assign staffing for the transaction process. The method 800, at step 870, may collect potential buyer additional information. For example, the method may include collecting sufficient information to complete a vehicle purchase transaction, including information on secured financing and payment plans and options, etc.

At step 880, the method 800 may include completing the vehicle purchase. The method 800 may end after step 880.

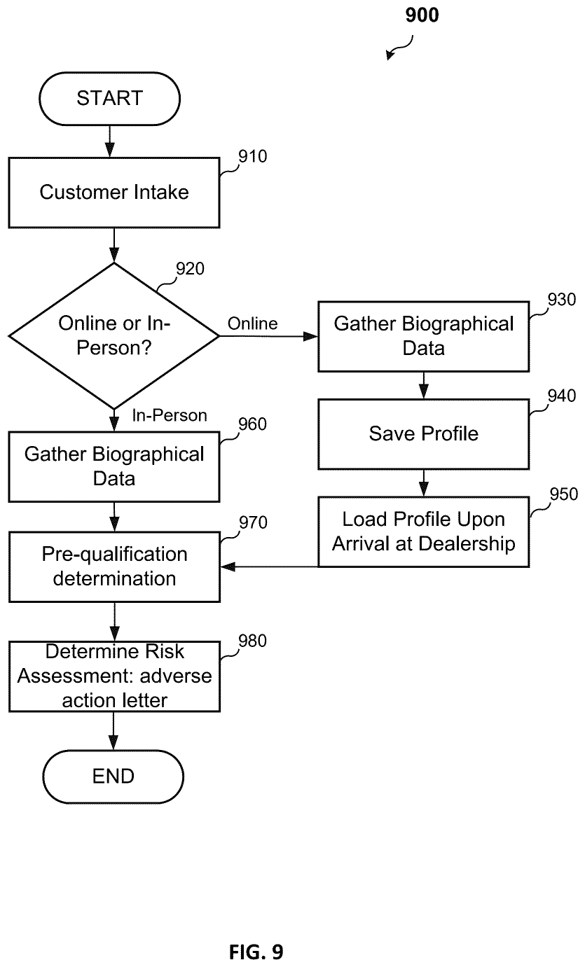

FIG. 9 is an exemplary flow diagram illustrating a method 900 for intake processing of customers associated with a vehicle transaction. The method 900 may be performed by a mobile device, such as dealership vehicle sales devices 162A, 162B of FIG. 1, or 220A, 220B, 220C of FIG. 2, or device 300 of FIG. 3. The method 900 may be methods of the device client 380 and/or the intake processing module 386, alone, or in combination with other modules such as modules 382, 384, 388.

Starting at step 910, the method 900 may begin with client intake (e.g., an initial intake of customer information). For example, the method 900 may be prompted by a potential customer to begin the process. In another example, the method 900 may detect a need to begin client intake without an explicit command from the user.

At step 920, the method 900 may determine whether the customer intake is performed online or in-person. In the example of FIG. 1, the intake may be performed in-person. In another example initial customer intake may be performed online after a potential customer has had a chance to review a car catalog available at a dealership. If the intake is online, then the method 900 may proceed to step 930. Otherwise if the intake is offline/in-person, then the method 900 may proceed to step 960. At step 930, the method 900 may gather profile data about the customer, including biographical data. At step 940, the method 900 may save the data (e.g., the biographical data) for use at a later time. In some embodiments, the method 900 may terminate or pause to wait for usage of the profile data. At step 950, the method 900 may load the customer profile upon the customer's arrival at the dealership.

Returning to step 960, the method 900 may gather profile data about the customer, including biographical data. At step 970, the method 900 may determine a pre-qualification for the customer. At step 980, based on the pre-qualification determination, the method 900 may determine a risk assessment including producing an adverse action letter if appropriate. The method 900 may terminate after step 980.

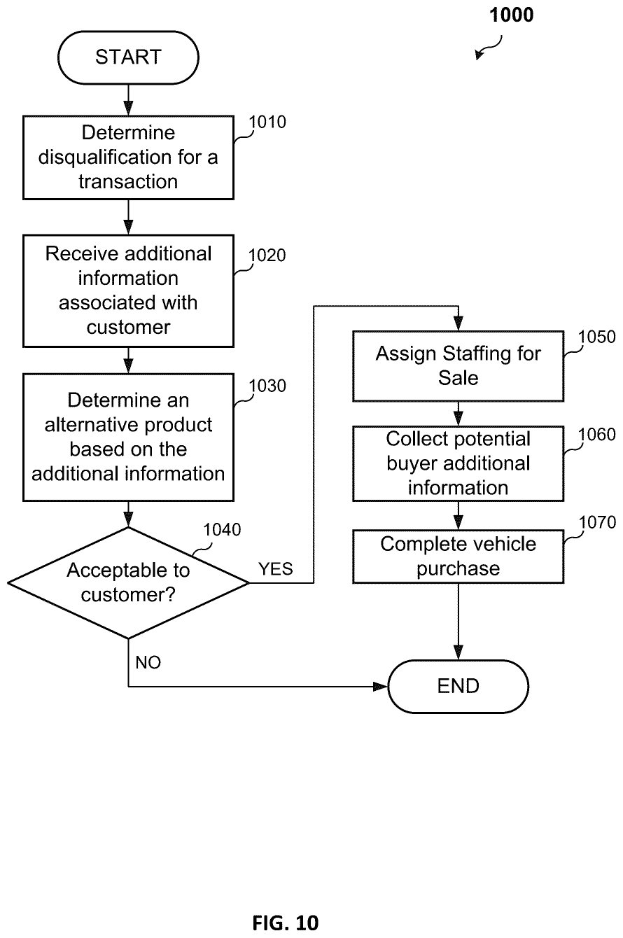

FIG. 10 is an exemplary flow diagram illustrating a method 1000 for reviving a sale subsequent to a disqualification determination. For example, the disqualification determination may be based on the disqualification determined in FIG. 8 at step 840. The method 1000 may be performed by a mobile device, such as dealership vehicle sales devices 162A, 162B of FIG. 1, or 220A, 220B, 220C of FIG. 2, or device 300 of FIG. 3. The method 1000 may be methods of the device client 380 and/or the sales revival module 388, alone, or in combination with other modules such as modules 382, 384, 386.

Starting at step 1010, the method 1000 may determine disqualification for a transaction. For example, after intake processing, the method 1000 may determine that a customer is not approved or qualified for purchase of a vehicle. In such instances, the customer is disqualified from a transaction involving the vehicle. At step 1020, the method 1000 may receive additional information associated with the customer. In some examples, the additional information may include additional biographical or financial information. In other examples, the additional information may include preferences, habits, or other indicators associated with the customer. For example, through collection of information, e.g., through sensors, it may become apparent that the customer may be satisfied with an alternative financial arrangement. In other examples, it may become apparent that the customer may accept alternative goods or services such as a lower-cost vehicle or alternative type of vehicle. At step 1030, the method 1000 may determine alternative goods or services such as an alternative product based on the additional information. At step 1040, the method 1000 may determine whether the alternative goods or services such as the alternative product is acceptable to the customer. If the alternative product is not acceptable, then the method 1000 may terminate. If the alternative product is acceptable to the customer, then the method 1000 may proceed to step 1050. At step 1050, the method 1000 may assign staffing for the sale or transaction. At step 1060, the method 1000 may collect potential buyer additional information. At step 1070, the method 1000 may complete the vehicle purchase or transaction. The method 1000 may terminate after step 1070.

Some portions of the detailed descriptions above may be presented in terms of algorithms and symbolic representations of operations on data bits or data structures within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proved convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “receiving, ,” “authenticating,” “storing,” “detecting,” “retrieving,” “granting,” “performing,” “locking,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present disclosure also relate to an apparatus for performing the operations herein. This apparatus may be specifically constructed for the required purposes, or it may be general purpose computer system selectively programmed by a computer program stored in the computer system. Such a computer program may be stored in a computer readable storage medium, such as, but not limited to, any type of disk including optical disks, CD-ROMs, DVD-ROMs, Blu-ray disks, magnetic-optical disks, read-only memories (ROMs), random access memories (RAMs), EPROMs, EEPROMs, magnetic-optical disk storage media, optical storage media, flash memory devices, solid state devices, other type of machine-accessible storage media, or any type of media suitable for storing electronic instructions, each coupled to a computer system bus.

The algorithms and displays presented herein are not inherently related to any particular computer or other apparatus. In some embodiments various general-purpose systems may be used with programs in accordance with the teachings herein, or it may prove convenient to construct a more specialized apparatus to perform the required method steps. The required structure for a variety of these systems will appear as set forth in the description below. In addition, the present disclosure is not described with reference to any particular programming language. It will be appreciated that a variety of programming languages may be used to implement the teachings of the disclosure as described herein.

It is to be understood that the above description is intended to be illustrative, and not restrictive. Many other embodiments will be apparent to those of skill in the art upon reading and understanding the above description. Although the present disclosure has been described with reference to specific exemplary embodiments, it will be recognized that the disclosure is not limited to the embodiments described, but can be practiced with modification and alteration within the spirit and scope of the appended claims. Accordingly, the specification and drawings are to be regarded in an illustrative sense rather than a restrictive sense. The scope of the invention should, therefore, be determined with reference to the appended claims, along with the full scope of equivalents to which such claims are entitled.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method implemented on a vehicle sales device, the method comprising:
receiving a set of information associated with a potential vehicle buyer, wherein the set of information comprises at least one financial metric, at least one biographical information, and information associated with a vehicle;
determining a set of criteria for a risk assessment for the potential vehicle buyer based on the set of information;
determining a risk profile based on the set of criteria as applied to the set of information;
determining whether the risk profile is within a threshold; and
upon a determination that the risk profile is within the threshold, initiating a process to complete a transaction associated with the potential vehicle buyer and the vehicle.

2. The method of claim 1, further comprising:
upon a determination that the risk profile is not within the threshold, disqualifying the potential vehicle buyer from the transaction associated with the vehicle; and
transmitting a notice to one of the potential vehicle buyer or a staff member of a dealership.

3. The method of claim 1, further comprising:
upon a determination that the risk profile is not within the threshold, generating an adverse action letter; and
notifying a staff member of a dealership of generation of the adverse action letter.

4. The method of claim 3, wherein the at least one financial metric comprises information associated with a soft credit inquiry that does not affect the potential vehicle buyer credit rating at a credit rating agency or organization.

5. The method of claim 1, wherein receiving the set of information associated with the potential vehicle buyer comprises one of receiving the set of information at a mobile device associated with the potential vehicle buyer, or receiving the set of information at a device associated with a dealership in possession of the vehicle.

6. The method of claim 3, further comprising:
receiving an additional set of information associated with the potential vehicle buyer;
determining an alternative product or service based on the additional set of information;
determining whether the alternative product is acceptable to the potential vehicle buyer; and
upon a determination of acceptance by the potential vehicle buyer, initiating a transaction for the alternative product or service for the potential vehicle buyer.

7. The method of claim 1, wherein the risk profile comprises information associated with a credit rating value.

8. The method of claim 6, further comprising:
collecting information upon detecting signals at the vehicle sales device; and
determining inferences based on the collecting information to determine the set of additional set of information.

9. The method of claim 8, wherein the detecting signals comprise either visual or audio cues detected at the vehicle sales device.
